(19) United States
(12) Patent Application Publication
(10) Pub. No.: US 2013/0318584 A1
(43) Pub. Date: Nov. 28, 2013

(54) LEARNING INFORMATION ON USAGE BY A USER, OF ONE OR MORE DEVICE(S), FOR CUMULATIVE INFERENCE OF USER'S SITUATION

(71) Applicant: QUALCOMM INCORPORATED, San Diego, CA (US)

(72) Inventors: Vidya Narayanan, San Diego, CA (US); Sanjiv Nanda, Ramona, CA (US)

(73) Assignee: QUALCOMM INCORPORATED, San Diego, CA (US)

(21) Appl. No.: 13/666,876

(22) Filed: Nov. 1, 2012

Related U.S. Application Data
(60) Provisional application No. 61/652,096, filed on May 25, 2012.

(51) Int. Cl. G06F 15/16; G06F 21/00

(52) U.S. Cl. 726/7; 709/204

(57) ABSTRACT

After authentication, one or more messages are generated by one or more devices that are operatively coupled via a communications network to a computer. Based on receipt of user input in a module in a device, a message transmitted by each device (in reliance on the authentication) includes information that is normally internal to the device and indicative of interaction of a user with the device. For example, the message may include an identifier of the device and internal information in the form of an identifier of the module (hardware and/or software), with which the user is interacting. Based on one or more such messages, at least one processor in the computer determines and stores in memory, a state of the user indicative of the user's situation. The user's state may be used in any manner, e.g. to trigger a function in an application or to start a new application.

### CROSS-REFERENCE TO PROVISIONAL APPLICATION

This application claims priority under 35 USC §119 (e) from U.S. Provisional Application No. 61/652,096 filed on May 25, 2012 and entitled “Learning Information On Usage By A User, Of Multiple Device(s), For Cumulative Inference Of User's Situation”, which is incorporated herein by reference in its entirety.

### FIELD

This patent application relates to apparatuses and methods for use in learning information on usage of one or more device(s) by a user, for cumulative inference of that user's situation.

### BACKGROUND

It is known in the prior art to use changes in data from one or more in-built sensors within a smart phone, to infer a situation of a user of the smart phone. For example, a smart phone can monitor changes of its own location on the earth in real time, by use of its in-built GPS sensor, to infer that the smart phone's user is in the process of driving a vehicle, when the location changes faster than a predetermined limit (e.g. 5 mph).

However, the inventors of the current patent application (“current inventors”) note that inferring a user's situation as described above does not work when data from a smart phone's in-built sensors happens to be insufficient to correctly infer the user's situation. Specifically, the current inventors note that in the above-described example, the GPS sensor provides the same location over a period of time in at least two cases, as follows: (1) the user has not moved during the period of time (or at least not moved sufficient to be sensed by the GPS sensor), and (2) when the smart phone is stationary because the smart phone is (deliberately or inadvertently) left unused on a desk or a table. Hence, the current inventors believe there is a need to learn information on usage by a user, of one or more devices, for cumulative inference of the user's situation, as discussed below.

### SUMMARY

One or more messages are generated by one or more electronic devices that are operatively coupled via a communications network, e.g. Internet, to a computer. In response to receipt of user input in (or other such usage of) one of the multiple electronic devices, a message transmitted by the electronic device includes at least an identifier of that electronic device. The message may additionally include information on its usage by a specific user, for example information that is normally internal to that electronic device (“internal information”), such as an identifier of a module (within the electronic device) with which the user is interacting. The module can be software or hardware or any combination thereof. One or more such messages are transmitted by the electronic device of several aspects to a computer or to another electronic device that is located at a common destination address, e.g. after authentication by use of credentials of the user.

In certain aspects, a common destination address is set up ahead of time to be, e.g. an address of a mobile device (or other such computer) authorized by a user whose interaction is to be monitored by the one or more electronic devices. Based on one or more messages from the one or more electronic devices, at least one processor (e.g. in the mobile device of the user, or in a computer coupled to the user's mobile device) determines and stores in memory, a state of the user. In some aspects, a specific user's state is determined based on one or more details in the internal information that indicate the specific user's situation, e.g. a place at which the specific user is currently located, and/or whether the specific user is alone or in the presence of other person(s). The specific user's state may be used in any manner, e.g. to trigger a function in an application software or to start execution of a new application software.

### BRIEF DESCRIPTION OF THE DRAWINGS

FIGS. 1A and 1B illustrate, in flow charts, operations of a method performed by a computer and a mobile device respectively, in certain described aspects.

FIG. 1C illustrate, in a flow charts, operations performed by a computer and a mobile device in combination with one another, in certain described aspects.

FIG. 1D illustrates, in a high level diagram, various electronic devices physically located in different places, such as a user's home and in a user's office that are authenticated to transmit information on the user's usage of each electronic device, such as a status of user interaction therewith and/or internal information such as an identifier of a module (within the electronic device) with which the user is interacting.

FIG. 2A illustrates, in a flow chart, operations performed by the electronic devices of FIG. 1D after authentication, to generate one or more messages containing device usage information and/or internal information indicative of interaction of the user with each electronic device.

FIG. 2B illustrates, in another flow chart, operations performed by a processor to collect and use the device usage information and/or internal information on user interaction that is received from the electronic devices of FIG. 1D in certain described aspects.

FIGS. 3A and 3B illustrate, in high level diagrams, electronic devices in the user's office and home respectively that generate streams of messages indicative of user interaction and transmit them to the user's mobile device in several aspects.

FIG. 4 illustrate, in a high level diagram similar to FIG. 1D, the above-described devices being used together to generate streams of user interaction messages and transmit them across the Internet to a server that in turn transmits a state of a user to that user's mobile device in several described aspects.

FIG. 5A illustrates, in a high-level block diagram, various software components of device 101Z in some of the described aspects.

FIG. 5B illustrates, in a flow chart, operations in certain described aspects.

FIG. 6A illustrates, in an intermediate-level block diagram, various software components of a cumulative inference module, in some of the described aspects.

FIG. 6B illustrates, in a flow chart, acts performed by a mobile device during initialization, in certain described aspects.

FIGS. 7A-7C illustrate, in high-level flow charts, acts performed by a mobile device (or a computer) during normal operation, in some of the described aspects.

FIGS. 8A-8C illustrate, in high-level block diagrams, hardware components in a mobile device, in a computer and in an electronic device respectively, in some of the described aspects.

### DETAILED DESCRIPTION

In several aspects of the type described below, a computer or mobile device determines a particular user's state by aggregating information from a set of one or more electronic devices with any one of which that particular user may be interacting. In some aspects, aggregation of information (e.g. received over time and/or from multiple devices) and determination of user state based on the aggregated information are performed automatically, by one or more computers or mobile devices acting alone or in combination with one another in any manner, as will be readily apparent in view of this description.

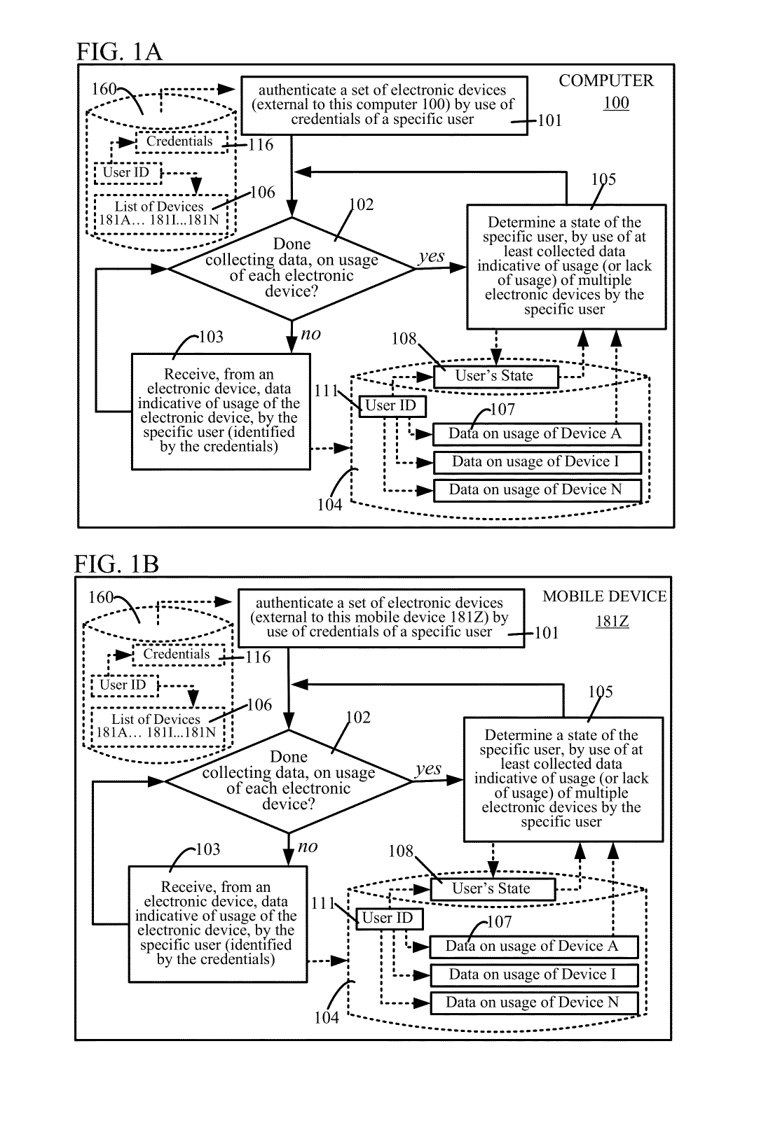

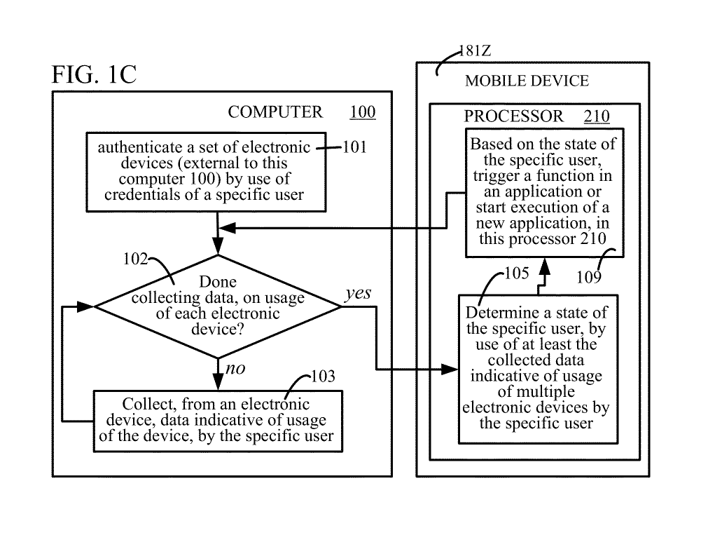

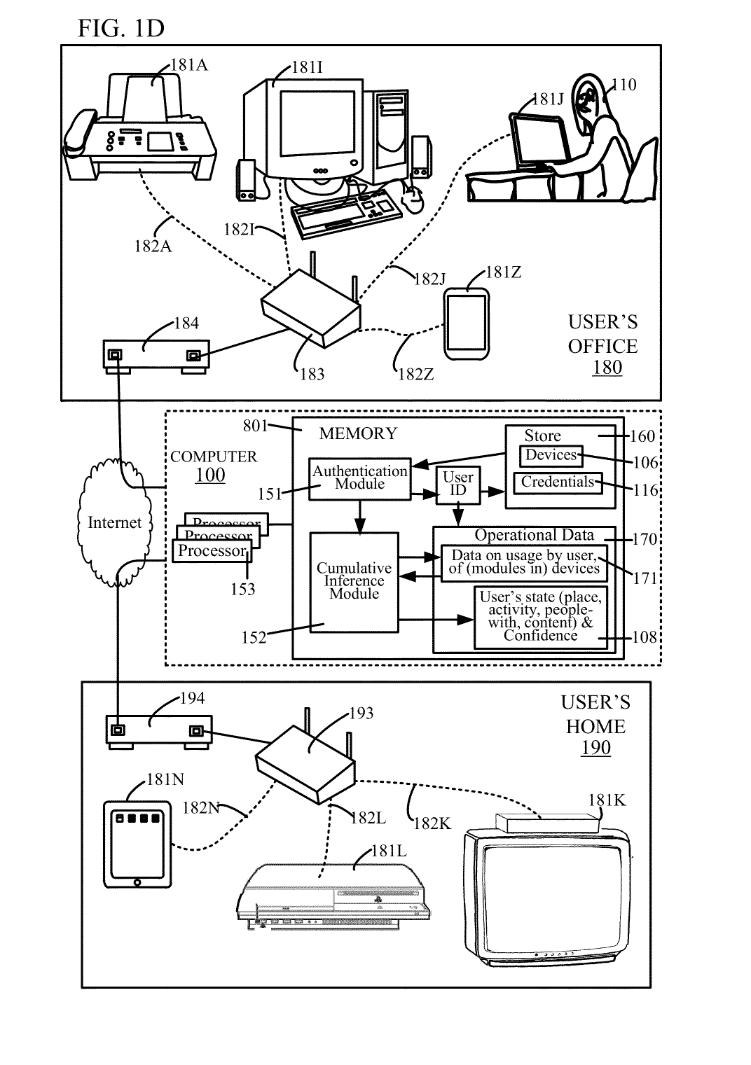

As discussed in detail below, the above-described aggregation of user interaction information and determination of user state 108 may be performed in some aspects by a computer 100 (as shown in FIG. 1A) or in other aspects by a mobile device 181Z, such as a smartphone or a laptop (as shown in FIG. 1B) or in still other aspects by any combination thereof (e.g. as shown in FIG. 1C). Mobile device 181Z that performs one or more acts of the type shown in FIGS. 1A-1C belongs to a specific user 110 (e.g. mobile device 181Z is used for a majority of time during each day by user 110). Depending on the aspect, computer 100 may be a server computer that is shared by multiple users including user 110, or computer 100 may be a desktop computer 181I (FIG. 1D) that specifically belongs to user 110. One or more acts performed by computer 100 as described below may alternatively be performed by a mobile device 181Z that also belongs to specific user 110 (whose state is determined in whole or in part based on, for example, a collection of information on that user's interaction with one or more electronic devices).

Electronic devices in a set, from which information on interaction of a specific user 110 is received, and aggregated in some aspects to determine that user's state, can be any electronic devices with which a human user may interact, such as a printer, a projector, or a visual display (e.g. in the user's office), or a game console 181L or tablet 181N (e.g. in the user's home). Electronic devices that supply user interaction information to be aggregated are located external to computer 100 (or in some aspects external to mobile device 181Z). These electronic devices are operatively coupled to computer 100 (or in some aspects coupled to mobile device 181Z) to exchange information indicative of a specific user's interaction, via a communications network, such as the Internet.

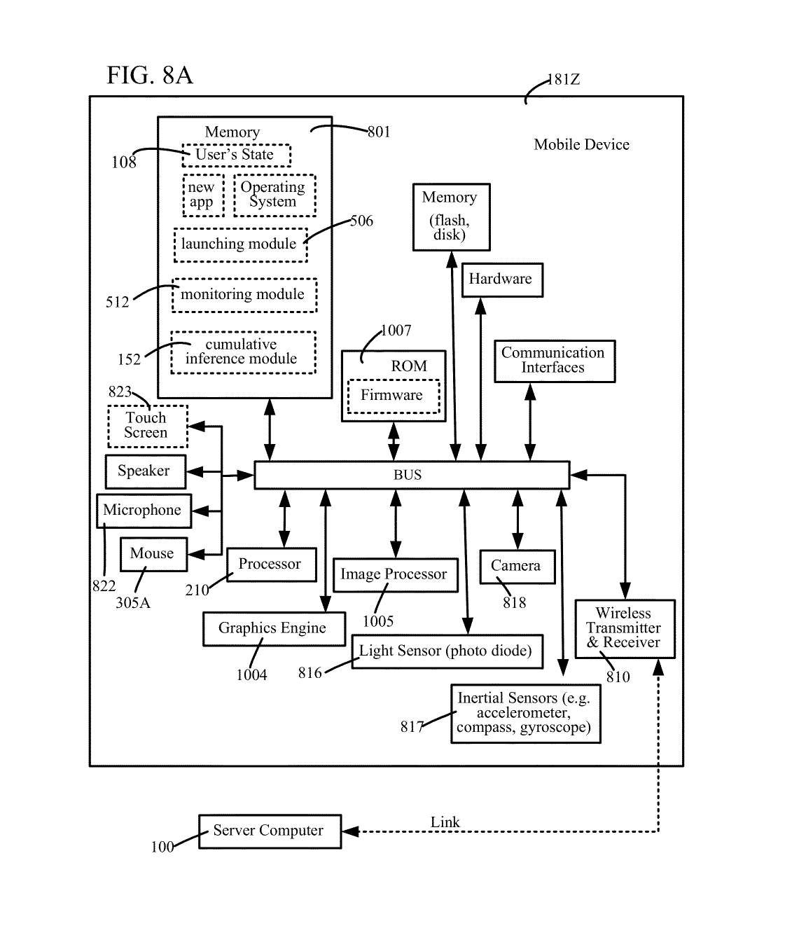

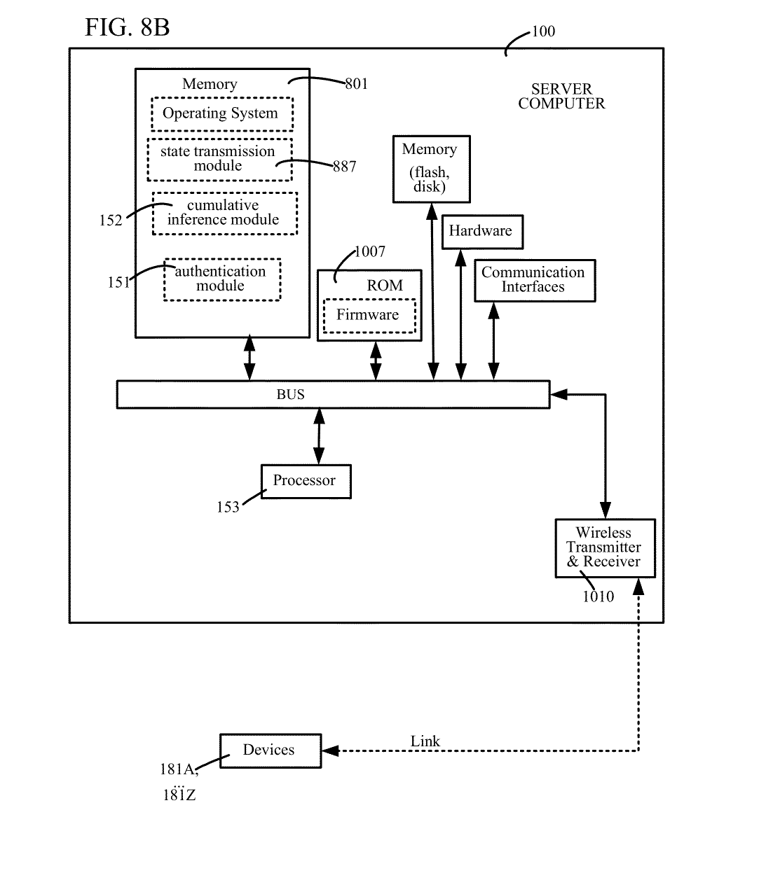

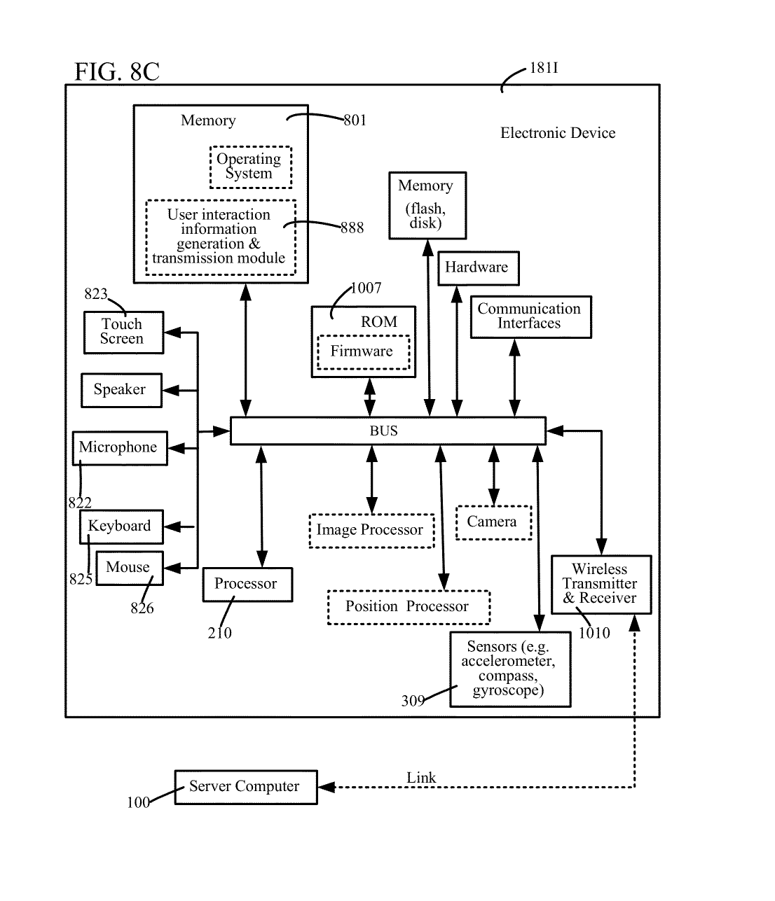

In some aspects, a processor 153 (FIG. 8B) in a computer 100 (FIG. 1A) authenticates in an act 101, a set of one or more electronic devices 181A-181N (FIG. 1D) that have been previously identified to computer 100, e.g. in a list 106 of the type shown in FIG. 1A, or any other such data structure (such as an array). Processor 153 of computer 100 may automatically identify such a list 106 by use of one or more credentials 116 (FIG. 1A) of a specific user 110. List 106 contains information on (e.g. Internet address of) one or more electronic devices 181A-181N (FIG. 1D) that are authorized by specific user 110 (FIG. 1D), to generate and transmit one or more messages that include information on their interaction with that specific user 110.

List 106 is typically identified to computer 100 by specific user 110 ahead of time via user input (e.g. by typing the list on a keyboard), prior to any user interaction information being aggregated by computer 100. In alternative aspects list 106 is not explicitly identified by specific user 110 to computer 100, and instead computer 100 automatically prepares list 106 as and when a message is first received from an electronic device 181I indicating that this electronic device 181I has been configured by the specific user 110 (e.g. when user 110 downloads and installs a software module, and supplies their credentials 116, wherein execution of the module causes a processor to generate and transmit information on interaction with that specific user 110).

In some aspects computer 100 sends credentials 116 of a specific user 110 to each electronic device 181I identified in list 106 (which is associated with the specific user 110), to establish a session therebetween, e.g. using the protocol HTTP or the secure protocol HTTPS. In alternative aspects, each electronic device 181I is individually configured by the specific user 110 to request and establish a session with computer 100, e.g. each device 181I has a module of the type described in the previous paragraph, and execution of the module causes a processor to send credentials of the specific user 110 to computer 100. Hence, authentication in act 101 may be done either by computer 100 or by electronic devices 181A-181N (FIG. 1D) that supply the information, depending on the aspect.

Also depending on the aspect, credentials 116 of a specific user 110 that are used in authentication in act 101 can be of different types, one example being user identifier (UID) 111 and password (PWD), another example being user identifier 111 and the specific user's fingerprint (not shown), still another example being user identifier 111 and a sample of the specific user's voice (not shown).

Authentication in act 101 provides two advantages in some aspects, as follows. Specifically, authentication in act 101 establishes trust, which serves two purposes: (a) provides permission for the electronic devices 181A-181N to yield up (in one or more messages) contextual information about this specific user 110 that is normally internal to each device 181I; and (b) provides permission for a processor in computer 100 (or in mobile device 181Z) to accept and use contextual information received from the user's devices to determine that specific user's state. For at least these reasons, authentication is performed in act 101 of some aspects, prior to collection of internal information (in one or more messages) from one or more devices 181A-181N (which is indicative of usage by user 110 of one or more devices 181A-181N).

After authentication in act 101 (FIG. 1A), in any manner apparent in view of this description, one or more of acts 102, 103 and 105 (FIG. 1A) are performed automatically and repeatedly in some aspects by one or more processors 153 of computer 100 (or alternatively by a processor 210 of mobile device 181Z), as follows. In act 102, computer 100 of some aspects checks whether data has been collected on usage of each electronic device 181I that is identified in list 106 of specific user 110 and if not performs act 103. In act 103, computer 100 receives from a specific electronic device 181I (e.g. identified in list 106), data indicative of usage of that specific device 181I, by the specific user 110 (as identified by the credentials used in act 101). Specifically, in one illustrative example (“polling example”) of act 103, computer 100 sends a message (e.g. periodically or asynchronously) to such an electronic device 181I (FIG. 1D) via a session established by authentication, to request data on user interaction (e.g. information internal to device 181I and indicative of interaction (if any) that may be occurring currently with user 110, and/or state of device 181I and/or interruptability status of user 110). Also in act 103, computer 100 receives a responsive message back from that electronic device 181I and computer 100 saves data 107 (on interaction of user 110 with device 181I) from the received message in a store 104 within computer 100, in association with the user identifier 111.

In another illustrative example (“asynchronous example”), computer 100 waits to receive one or more messages (also called “user interaction” message) from each device identified in list 106 (and one or more electronic devices automatically send to a common destination address, one or more messages periodically or asynchronously in response to a predetermined event), and on receiving each message in act 103 computer 100 saves the received data 107, into store 104 in association with identifier 111 of specific user 110.

When the checking in act 102 indicates that data has been received from one or more electronic devices in a set (e.g. as identified in list 106 of specific user 110), in some aspects computer 100 goes to act 105 to determine (and store in memory) a state 108 (FIG. 1A) that is indicative of a situation of specific user 110, e.g. to identify a place where specific user 110 is currently located and/or presence of other person(s) in a vicinity of specific user 110 and/or an activity being performed by specific user 110. The state 108 of specific user 110 is determined automatically by computer 100 in act 105 based on at least data 107 that is received in one or more messages and is indicative of usage (or non-usage) of one or more electronic devices, by that specific user 110 (who was identified by their credentials). Depending on the aspect, state 108 may be determined, e.g. by performing a table lookup, using as one or more inputs to one or more table(s), one or more portion(s) of data 107 received in act 103 from one or more devices 181A-181N). On completion of act 105, computer 100 stores the user's state 108 in memory (e.g. in store 105) and returns to act 102 (described above). Accordingly, some aspects of computer 100 of FIG. 1A determines a state 108 of a specific user 110 based on data that is aggregated or combined by use of data 107 from one or more messages received in act 103 via a communications network (e.g. Internet) from one or more external electronic devices 181A-181N that were expressly authorized by that specific user 110, e.g. in list 106, to generate and transmit information on interaction with (or usage by) that specific user 110.

In certain aspects, computer 100 is implemented as a server computer in which processor 153 performs each of acts 101, 102, 103 and 105 (as illustrated in FIG. 1A), and this server computer then transmits the state 108 of a specific user 110 to a mobile device 181Z of that specific user (e.g. at the end of act 105, or in response to a request from the mobile device). In other aspects, one or more processors 210 in mobile device 181Z of the specific user 110 perform each of the above-described acts 101, 102, 103 and 105, as illustrated in FIG. 1B. Furthermore, in certain alternative aspects, one or more of acts of the type described herein are performed in computer 100 while other acts of the type described herein are performed by another processor in a device that is external to (e.g. operably coupled to) computer 100, as shown in FIG. 1C.

Specifically, in some alternative aspects illustrated in FIG. 1C acts 101, 102 and 103 are performed by processor(s) 153 in computer 100 while act 105 (and an additional act 109, described below) is/are performed by processor(s) 210 in the specific user's mobile device 181Z. Hence, in certain aspects, one or more processor(s) 210 in mobile device 181Z may determine state 108 of user 110 in whole or in part based on data 107 received in a single message from a single electronic device 181I that is external to mobile device 181Z, e.g. in combination with other data within mobile device 181Z, such as one or more measurements made locally by one or more sensor(s) 816, 817, 810 or 818 (FIG. 8A) in mobile device 181Z. In several aspects, after performance of act 105, a processor 210 in device 181Z performs an act 109 as follows. In act 109, processor 210 triggers a function in an existing application software or starts execution of a new application software within the current mobile device 181Z (e.g. execution by processor 210), based on the specific user's state determined in act 105. Similarly, in other aspects of the type illustrated in FIG. 1A, a mobile device 181Z (FIG. 1C) performs act 109 after receipt of the specific user's state from a computer 100 that performs act 105 (FIG. 1A).

FIG. 1D illustrates electronic devices 181A . . . 181I . . . 181J that are located in a specific user's office 180, such as a desktop computer 181I, a multi-function printer (also called MFP, including a printer, a copier, a scanner and a fax machine) 181A and a laptop computer 181J. Office 180 shown in FIG. 1D belongs to the specific user 110, e.g. office 180 is used for a majority of time during each day (or is owned or leased) by this specific user 110, and accordingly devices 181A-181J that are located in office 180 are not shared with any other person, and instead these devices 181A-181J belong to this specific user 110. Other examples of electronic devices 181A-181J that may be physically located within office 180 and that may belong to the specific user 110 (FIG. 1D) are a projector and a visual monitor, depending on the aspect.

In an example, each of electronic devices 181A-181J in office 180 is configured by the specific user 110 for authentication, which is followed by generation and transmission of one or more messages that identify user interaction, e.g. in response to receipt of input from the specific user via I/O hardware therein, such as a touch screen 823, a keyboard, a mouse, a stylus, a pen, a microphone 822, or a camera 818. In an aspect illustrated in FIG. 1D, electronic devices 181A . . . 181I . . . 181J are physically located in the specific user's office 180, and are directly coupled by corresponding links (on which are shown message sequences 182A . . . 182I . . . 182J) to a wireless router 183 that is in turn connected via a cable modem 184 to computer 100. In other aspects, such electronic devices 181A . . . 181I . . . 181J may be connected via Ethernet over coax cable or even across the Internet, via a modem 184. A specific manner in which electronic devices 181A . . . 181I . . . 181J in specific user's office 180 are connected to computer 100 can be different in different aspects.

In addition to electronic devices 181A-181J located in the specific user's office 180, similar electronic devices 181K-181N may be located in that specific user's home 190, connected via a wireless router 193 and a modem 194 to computer 100. Hence, the specific user 110 configures electronic devices 181K-181N in home 190 (which belong to user 110) in a manner similar to configuration of electronic devices 181A-181J in office 180 of user 110. Specifically, the specific user 110 configures devices 181K-181N to generate and transmit corresponding sequences of user interaction messages to computer 100. By configuring devices 181A-181N in the manner described herein, user 110 approves tracking of that user's own interaction, with each of that user's electronic devices 181A-181N.

In summary, each device 181I in the above-described set of devices 181A-181N is configured by user 110, for authentication with computer 100 followed by generation and transmission of one or more messages to computer 100 (or to a destination identified by computer 100, depending on the aspect). Although hardware and software in devices 181K-181N in that home 190 of user 110 is normally different from hardware and software in devices 181A-181J at office 180 of that user 110, methods of type described herein may be used with all electronic devices 181A-181N with which the specific user can interact by manually providing input thereto, regardless of where each electronic device is physically located (e.g. in the specific user's office 180 or the specific user's home 190 as per FIG. 1D).

In several aspects, computer 100 (FIG. 1D) includes an authentication module 151 (which implements a means for authenticating), and a cumulative inference module 152 (which implements a means for determining and a means for transmitting). Modules 151 and 152 may each be implemented in either custom hardware or software executed by a processor or a combination thereof. Authentication module 151 uses configuration information in a store 160 included in the memory of computer 100 with the identifier 111 of a specific user 110, to obtain credentials 116 from store 160 and authenticate all electronic devices 181A-181N that are identified in list 106, by use of that user's credentials 116, e.g. as described above in reference to act 101 (FIG. 1A).

After authentication by module 151, acts 102, 103 and 105 (FIG. 1A) are performed by cumulative inference module 152 (FIG. 1D), using operational data 170. Operational data 170 includes data 171 on the user's usage of electronic devices 181A-181N, such as information that is normally internal to electronic devices 181A-181N. Specifically, data 171 identifies, for example, usage by specific user 110 of the set of electronic devices 181A-181N, and in some aspects the data 171 is specific to each of one or more modules within each of electronic devices 181A-181N. Cumulative inference module 152 of some aspects also uses this data and any other data that may be available (e.g. from sensors of a mobile device of the specific user) to identify the specific user's state 108 (which is written by processor 210 to memory 801 of FIG. 8A, e.g. as operational data 170 of FIG. 1D).

Specifically, while working in office 180, a specific user 110 may select any electronic device 181J from among the set of electronic devices 181A-181N in FIG. 1D (e.g. with the selection being limited by the specific user's current location being in office 180 or home 190). Then, within the user-selected electronic device 181J, the specific user 110 may further select a specific hardware and/or software module to use in order to do their work, from among one or more software/hardware modules that are included in an electronic device 181J.

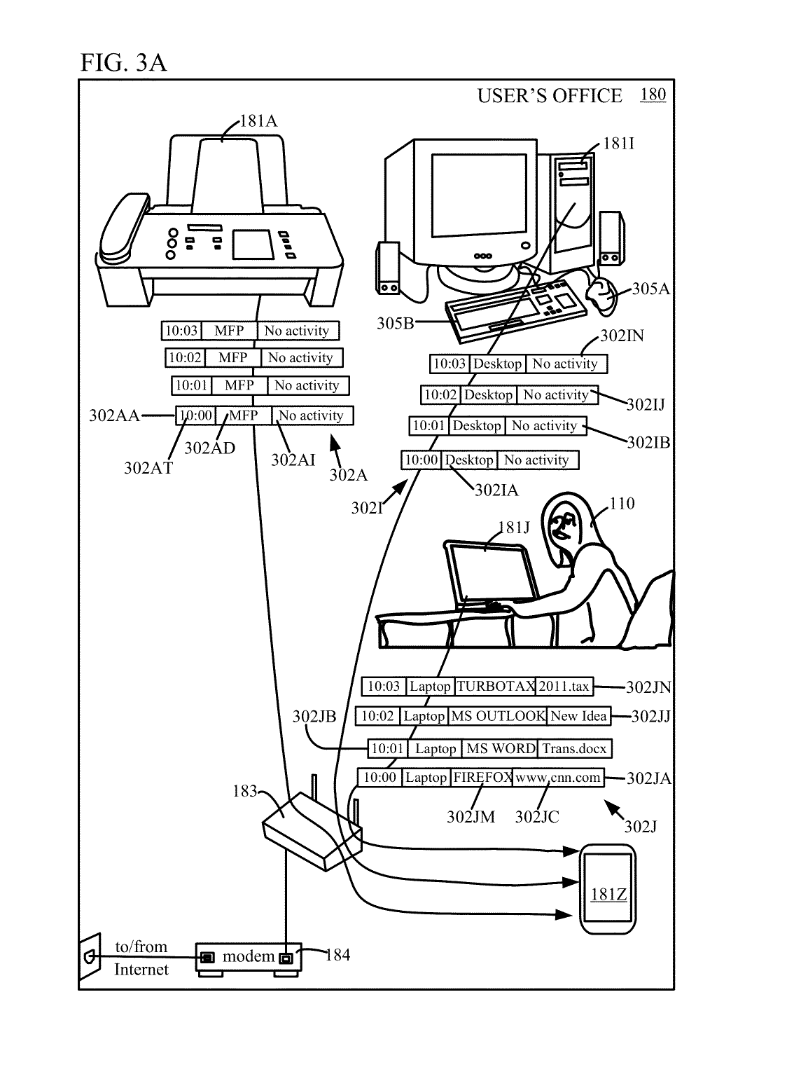

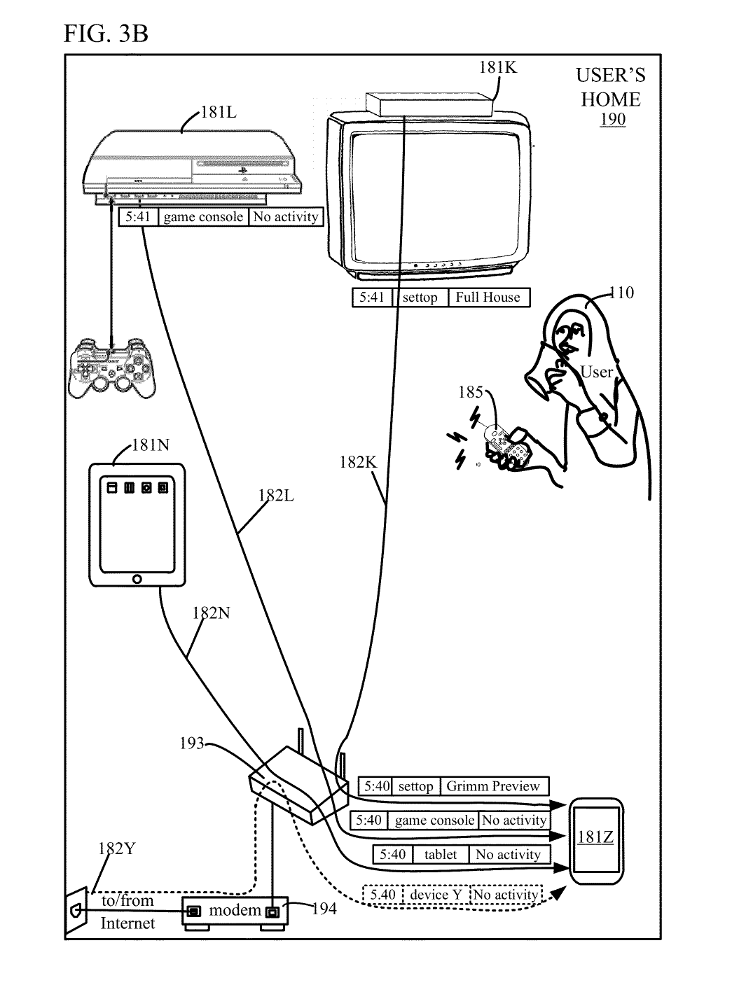

The user-selected module can be any hardware circuitry, or any software being executed by a processor, or any combination thereof that can receive user input in electronic device 181J. Next, specific user 110 uses the selected module, and on doing so the module in electronic device 181J receives user input, e.g. through I/O hardware normally used to receive user input, such as a mouse 826 (FIG. 8C), a keyboard 825, or a touch screen 823. Receipt of user input (such as key-strokes or mouse-clicks) is used by electronic device 181J to identify a user-selected module therein, and automatically prepare and transmits a user interaction message. Depending on the aspect, each electronic device 181J may transmit such a message periodically or asynchronously in response to detection of a predetermined event (such as receipt of user input). In an illustration shown in FIG. 3B, user input on a remote control 185 is received by a set-top box 181K and the user input is included in a sequence of messages 182K that are transmitted to device 181Z.

As noted above, to provide user input, the specific user makes at least two selections in some aspects, and depending on the aspect either or both these selections may be explicitly identified in one or more user interaction messages from one of devices A≦I≦N in the set. Hence, in some aspects, a user interaction message explicitly includes user interaction information that is normally internal to electronic device 181J, such as an identity of a software and/or hardware module therein currently receiving user input and/or interacting with the specific user. In certain aspects, a user interaction message further includes additional information that is internal to the user-selected module that receives user input, such as content received in user input and/or content being displayed to the specific user 110.

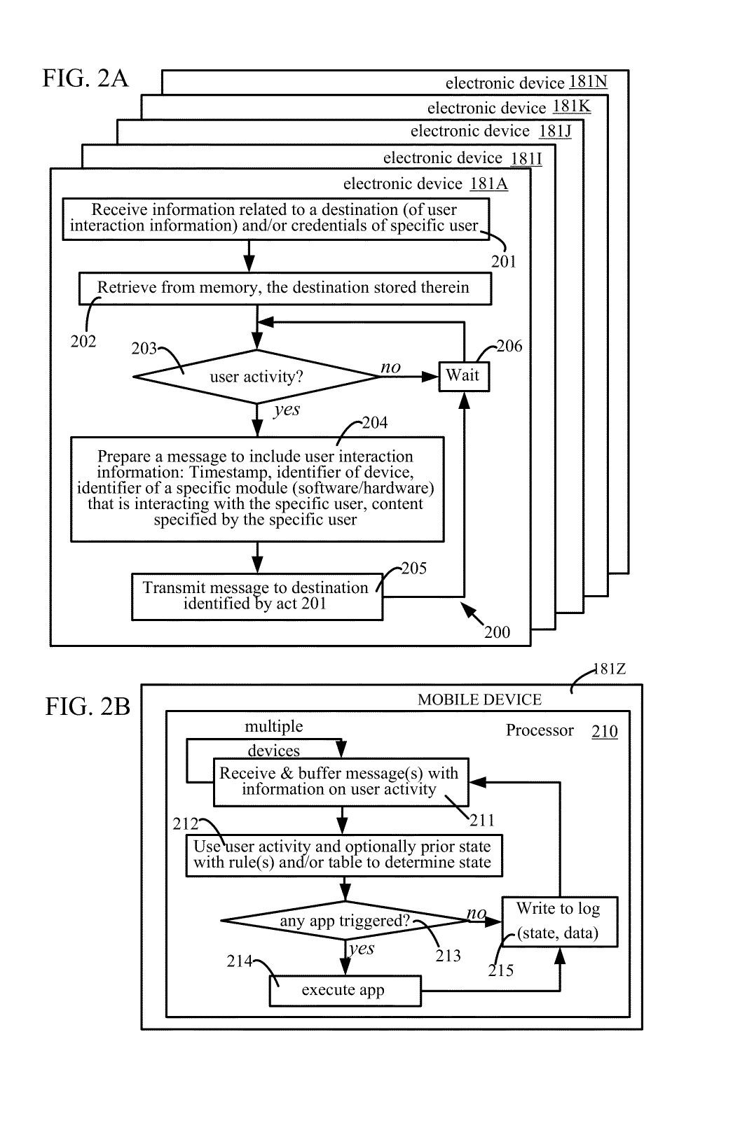

In some illustrative aspects, electronic devices 181A-181N are each configured by specific user 110, e.g. by specific user 110 installing a module 888 (FIG. 8C) into each device 181I to perform a method of the type illustrated in FIG. 2A. Module 888 in some aspects includes software instructions in a memory 801 that when executed by a processor 210 cause processor 210 to perform a method of the type illustrated in FIG. 2A. The specific user 110 may additionally configure a mobile device 181Z as the destination for a sequence of user interaction messages that are received from one or more of electronic devices 181A-181N via the Internet, modem 184 and router 183. Specifically, in some illustrative aspects, user 110 configures devices 181A-181N to transmit corresponding sequences 182A-182N of user interaction messages to mobile device 181Z. User 110 may additionally configure device 181Z as the destination for a sequence 182Y of user interaction messages from a device (not shown in FIGS. 3A, 3B) on the Internet via a modem connected to device 181Z.

In some aspects, each user interaction message is generated by each electronic device 181I performing a method 200 illustrated in FIG. 2A, and described next. In act 201, an electronic device 181I (which is representative of each of the electronic devices 181A-181N in the set identified by the user, unless stated otherwise) receives information related to a destination to which user interaction information is to be transmitted and/or receives credentials of the specific user 110. Specifically, act 201 is performed during an initialization phase (or a configuration phase) of electronic device 181I which may receive a destination that the specific user may have set up ahead of time, e.g. as a certain port at a specific URL of computer 100. The received destination is stored in a local memory of electronic device 181I in act 201, for future use in transmitting user interaction information.

In several aspects of act 201, electronic device 181I additionally receives credentials of the specific user 110, e.g. user name and password, as additional user input, which is also stored in memory of electronic device 181I in act 201. The just-described destination and optionally credentials may be used by electronic device 181I to asynchronously transmit user interaction information to computer 100 in some aspects. However, certain aspects of act 201 may receive the credentials but not the destination (see “polling example” above), wherein electronic device 181I uses the credentials to authenticate computer 100.

In some aspects of act 202, electronic device 181I retrieves from its local memory (also called non-volatile computer-readable memory) a predetermined destination to which electronic device 181I is configured to send a user interaction message. Next, in act 203, electronic device 181I checks if there is currently any interaction between itself and the specific user 110 (as identified by their credentials), and if not then electronic device 181I waits (as per act 206) for a predetermined duration (e.g. 1 minute) and then returns to act 203.

In certain aspects, before waiting in act 203 (FIG. 2A), electronic device 181I sends a user interaction message (e.g. message 302AA in FIG. 3A) to the predetermined destination, including in the message the following fields: a time stamp field 302AT, and an identifier field 302AD that uniquely identifies the electronic device A in the set, and an indication field 302AI that indicates there is no user interaction. Note that in FIG. 3A, text is shown in the fields 302AT, 302AD and 302AI of message 302AA for ease of understanding, although as would be readily apparent to the skilled artisan one implementation of such messages uses numbers, e.g. instead of the word “MFP” in identifier field 302AD, a number is used to identify the multi-function printer (which is the only MFP that belongs to this specific user 110). As the identifier in field 302AD needs to be unique for a specific user 110, when user 110 has two MFPs then each of them may be identified with a number in addition to MFP, e.g. MFP1, MFP2.

In some aspects, the sequence 3021 (FIG. 3A) includes a series of messages 3021A, . . . 3021N . . . that are generated repeatedly and indefinitely, at a periodic interval (e.g. once every minute) for as long as electronic device 181I receives power, to identify user interaction (or optionally lack of user interaction) at electronic device 181I. Such a message 3021J from an electronic device 181I is also referred to, in the following description, as a user interaction message. In several aspects, computer 100 described above is implemented by the specific user's mobile device 181Z.

In many aspects, each electronic device 181I (FIG. 3A) sends a corresponding stream 3021 of messages to a destination that is common to all electronic devices 181A-181N in the set. In some aspects, the common destination is set up ahead of time to be, e.g. an address of a mobile device 181Z (FIG. 3A) of the specific user 110 whose interaction is being monitored by the set of electronic devices 181A-181N. Hence, in such aspects, a single device 181Z receives multiple streams, such as streams 302A-302J of user interaction messages from the corresponding multiple electronic devices 181A-181J, each of which identifies any hardware or software module therein when used by the specific user (the same user that configured the electronic devices 181A-181J to transmit that user's interaction in user interaction messages).

Referring back to FIG. 2A, in some aspects, no message is sent when electronic device A goes from act 202 to act 203. In such aspects, a mobile device 181Z at the destination treats failure to receive any message from an electronic device A same as receipt of message 302AA which indicates there is no user interaction at device A. The just-described aspects conserve battery power in device A, because no message is sent when there is no user interaction with device A.

A duration of waiting in act 203, to check again for user interaction, depends on a number of factors, such as whether device I is receiving power from an adapter v/s from a battery, etc. When the answer in act 202 (FIG. 2A) is yes, then in a subsequent act 204, device A prepares another user interaction message, including a time stamp, an identifier of device A, and an indication of user interaction (such as “User interaction detected” or a number indicative of this status).

Depending on the aspect, at this stage, device A may include in the user interaction message prepared in act 204, another identifier field that uniquely identifies a module (in the device A) with which the specific user is currently interacting. Specifically, in an example illustrated in FIG. 3A, a user interaction message 302JA prepared by device 181I in act 204 includes a name of an application program (also called “application software” or simply “application”), in a field 302JM (also called “module identifier” field) that is currently in use by the user 110. Note that the identifier in field 302JM is normally internal to device 181I but this identifier is included in information (e.g. data 107 of FIG. 1A) that is now explicitly transmitted in one or more user interaction messages, e.g. in message 302JA.

In the example illustrated in FIG. 3A, user interaction message 302JA may be prepared to further include other information internal to electronic device 181J, such as an identifier of content in field 302JC. Note that the identifier in field 302JC (also called “content identifier” field) is also normally used in operations (e.g. on execution of the application software) internal to electronic device 181J but in some embodiments this content identifier is included in information (e.g. data 107 of FIG. 1A) that is now explicitly included and transmitted in user interaction message 302JA. Other such fields included in information (e.g. data 107 of FIG. 1A) transmitted in a user interaction message may identify, for example the type of input hardware in electronic device 181J (such as a keyboard) which is being used by specific user 110.

Referring back to FIG. 2A, such a user interaction message is then transmitted in act 205, followed by going to act 203 to wait for a predetermined duration (e.g. 1 minute) and then repeat acts 202, 204 and 205 described above in reference to FIG. 2A. When each of N electronic devices in the above-described set perform acts 201-206, corresponding N user interaction messages are generated therefrom, and these N messages are received by a processor that performs acts 211-215 illustrated in FIG. 2B, and described below.

Hence, over a period of time during which specific user 110 is using electronic device 181I (FIG. 3A), a stream of messages 3021, containing information on user interaction with electronic device 181I are generated and transmitted by electronic device 181I, as illustrated by the four messages shown in FIG. 3A, specifically message 3021A at time 10:00, followed by message 3021B at time 10:01, followed by a message at time 10:02, followed by message 3021N at time 10:03. Note that although only four messages are shown in FIG. 3A as being included in sequence 3021, it is to be understood that such messages are generated once every minute in the illustrated aspect.

Moreover, although messages 302JA-302JN in a stream 302J are illustrated in FIG. 3A as being generated periodically based on a 1-minute timer, such messages may alternatively be generated asynchronously e.g. in response to an interrupt that is driven by receipt of input from the specific user (such an interrupt, which is based on user input is unlikely to occur at precisely 1 minute intervals). Furthermore, although messages 302JA-302JN are illustrated in FIG. 3A as being transmitted spontaneously by electronic device 181J, in other aspects electronic device 181J stores the user interaction information locally in a memory therein until a poll message is received (e.g. from either computer 100 or from mobile device 181Z, depending on the aspect), and electronic device 181J responds to the poll, by transmitting message 302JB.

In the example illustrated in FIG. 3A, at time 10:00, a specific user 110 is currently working on their laptop which has been configured ahead of time in list 106, as electronic device 181J. Moreover, before this time 10:00, electronic device 181J has been authenticated with computer 100, as described above. Also by this time 10:00, the specific user has also been authenticated by electronic device 181J, e.g. the specific user has supplied credentials as input to electronic device 181J during login. In this example, at time 10:00 an application program named FIREFOX (a browser application available from Mozilla Corporation) is a software module that interacts with specific user 110 (e.g. receives user input therein, such as characters typed on a keyboard 305B, and/or clicks on buttons of a mouse 305A). Hence, electronic device 181J includes the name “FIREFOX” in a module identifier field 302JM of a message 302JA (e.g. as one part of data 107 of FIG. 1A) that is prepared by electronic device 181J as per act 204 (see FIG. 2A).

Message 302JA with module identifier field 302JM may then be transmitted by electronic device 181J (either to computer 100 or to mobile device 181Z, depending on the aspect), while in other aspects electronic device 181J additionally includes in an enhanced version of message 302JA a content identifier field 302JC (e.g. as another part of data 107 of FIG. 1A) identifying the specific content with which specific user 110 is interacting, e.g. the content displayed to specific user 110 may be a form on a web page at the website address ‘www.cnn.com’ as shown in field 302JC in FIG. 3A.

At time 10:01 (FIG. 3A) in device 181J, another application program, named MS WORD (which is word processing software available from Microsoft Corporation) is a software module that interacts with specific user 110, and therefore a user interaction message 302JB automatically prepared by device 181J includes the name “MS Word” in the module identifier field (e.g. as one part of data 107 of FIG. 1A) and further includes an identifier of content, e.g. the name “Trans.docx” in the content identifier field (e.g. as another part of data 107 of FIG. 1A) to identify a specific document in which user input is currently being received from (e.g. currently being edited by) specific user 110.

At time 10:02, in device 181J, another application program, named MS OUTLOOK (which is email client software available from Microsoft Corporation) is another software module that interacts with specific user 110 and therefore user interaction message 302JJ prepared by device 181J includes the name “MS OUTLOOK” in the module identifier field (e.g. as one part of data 107 of FIG. 1A) and further includes the subject “New Idea” in the content identifier field (e.g. as another part of data 107 of FIG. 1A) to identify a specific email message that is being read or written by specific user 110. At time 10:03, in device 181J, yet another application program, named TURBOTAX (which is tax preparation software available from Intuit Inc.) is yet another software module that interacts with specific user 110 and therefore user interaction message 302JJ prepared by device 181J includes the name “TURBOTAX” in the module identifier field (e.g. as one part of data 107 of FIG. 1A) and further includes the file name “2011.tax” in the content identifier field (e.g. as another part of data 107 of FIG. 1A) to identify a specific file that is currently being used by specific user 110.

At this stage, if specific user 110 leaves device 181J and starts to work at device 181A (which in this example is a multi-function printer or MFP), then the next user interaction message prepared by device 181J (at time 10:04) indicates that there is no activity. At this stage, the next message prepared by device 181A (also at time 10:04) automatically identifies whichever one of modules within device 181A that specific user 110 is using (e.g. any one of PrintCircuit, CopierCircuit, ScanCircuit, and FaxTxCircuit may be automatically identified as the name of the module in use in device 181A). For example, if specific user 110 starts to send a fax, on performance of act 204 (FIG. 2A) by device 181A, the module identifier field in the next user interaction message (not shown; at time 10:04) to be transmitted in stream 302A is set (e.g. as one part of data 107 of FIG. 1A) by device 181A to an identifier of the module that transmits faxes, such as FaxTxCircuit and further includes in the content identifier field (e.g. as another part of data 107 of FIG. 1A) a number “571-273-8300” entered by the specific user, to identify a destination fax machine. In the just-described example, FaxTxCircuit is a hardware module (e.g. electronic circuitry) within device 181A that is identified in the user interaction message transmitted by device 181A.

In the above-described example, at another time, in response to user 110 making a copy, CopierCircuit is identified in the user interaction message transmitted by device 181A. At still another time, in response to user 110 scanning a document, ScanCircuit is identified (e.g. as one part of data 107 of FIG. 1A) in the user interaction message transmitted by device 181A. Similarly, other such hardware and/or software being used by user 110 is automatically identified by other devices, depending on hardware and software therein (e.g. if specific user 110 is listening to music, external speakers are identified by device 181I in the user interaction message of some aspects).

When specific user 110 (FIG. 3A) starts using mobile device 181Z, in some aspects, mobile device 181Z no longer receives messages in streams 302A-302J as all these streams contain “no activity” messages. Alternatively, it is no longer necessary for mobile device 181Z to receive the specific user's state 108 from computer 100. Instead, when specific user 110 (FIG. 3A) starts using mobile device 181Z, mobile device 181Z begins to receive user input directly via its own I/O hardware and/or sensors 521. In certain aspects, at this stage, the above-described roles of devices 181J and 181Z are reversed, as follows. Specifically, mobile device 181Z broadcasts a command to all electronic devices 181A-181N that are identified in list 106 to overwrite a specific destination address stored locally therein, with an address of another device 181J, to be used as a new destination. Thereafter, mobile device 181Z generates its own sequence of user interaction messages, and in this manner device 181J starts receiving message streams 302A-302I, and begins to process the user interaction information as follows. Specifically, the user interaction information received in streams 302A-302I is processed in some aspects by a processor 210 performing a method illustrated in FIG. 2B, as described below.

In act 211 (FIG. 2B), a processor 210 (either in computer 100 or in mobile device 181Z, depending on the aspect) receives a user interaction message, and this act is repeatedly performed to receive multiple such messages from any of devices 181A-181N that belong to the set (FIG. 1A). Note that in act 211 processor 210 may not necessarily receive user interaction messages from each and every one of the N devices in the set, e.g. because one or more of devices 181A-181N may be powered down, or moved out of office 110 (e.g. laptop device 181J can be moved to another room). Therefore, any messages from one or more of devices 181A-181N that are received in act 211 are buffered as data 171 (also called user interaction data) as shown in FIG. 1D.

Thereafter, in act 212, processor 210 processes user-interaction information in the aggregate across the multiple messages in data 171 buffered by act 211 (FIG. 2B), e.g. by execution of cumulative inference module 152 (FIG. 1D). The processing of user interaction data 171 in act 212 (FIG. 2B) may optionally use a prior value of the user's state 108 and/or data from a log, to determine the specific user's state 108 based on that specific user's usage of (or interaction with) multiple devices, e.g. by module 152 (FIG. 1D) applying one or more rules and/or performing a table lookup. When a rule is satisfied, the rule may identify to processor 210 the specific user's state 108 either partially or fully depending on the rule. A specific user's state 108 that is only partially identified to processor 210 may be used as input in a lookup table or in another rule that completely identifies to processor 210 the specific user's state 108 (e.g. based on the partial identification, and newly-received device-usage information in one or more messages).

The specific user's state 108 obtained in act 212 (FIG. 2B) is then used by processor 210 in act 213 (FIG. 2B) to identify software (also called “app”) that has been associated therewith, ahead of time. If the user state 108 has associated software, then in some aspects, state information (e.g. identifying which rules were satisfied and which rules failed, and other intermediate information, such as partial identification of the specific user's situation) is written by processor 210 to a log as per act 215 (FIG. 2B) for processing of user interaction data 171 in future, followed by returning to act 211. If software for the specific user's state 108 is identified in act 213 (FIG. 2B), then another act 214 (FIG. 2B) is performed by processor 210 to execute the software, followed by returning to act 211. On returning to act 211 (FIG. 2B), processor 210 awaits messages from multiple electronic devices 181A-181N which themselves wait for the predetermined duration (as per act 206 in FIG. 2A) before generating messages in their respective N sequences.

Accordingly, by performing acts 211-215 described above, processor 210 (FIG. 2B) determines the specific user's state 108, based on the specific user's interaction with any one of devices 181A-181N in the set, even when the user is not using a device that contains processor 210 (such as a mobile device 181Z, which may be left stationary on a desk). Therefore, even when a specific user is not using mobile device 181Z (as shown in FIG. 3A), processor 210 in 101Z determines the specific user's state 108 based on data 171 collected from multiple sequences 302A-302J of user interaction messages from corresponding multiple devices 181A-181J.

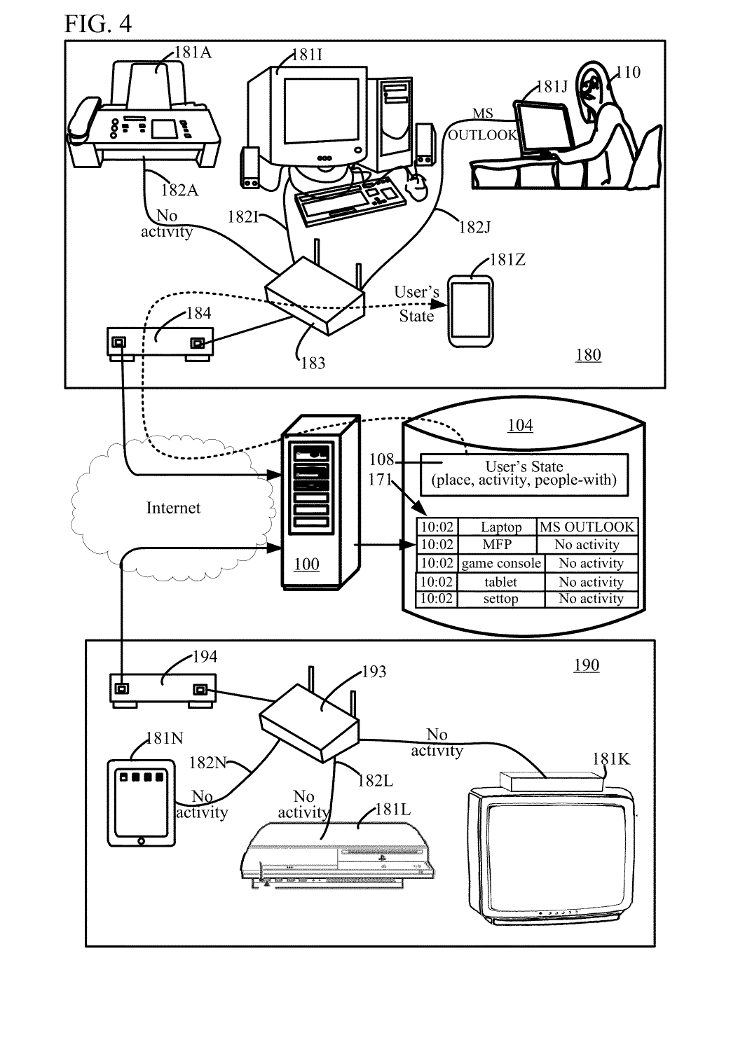

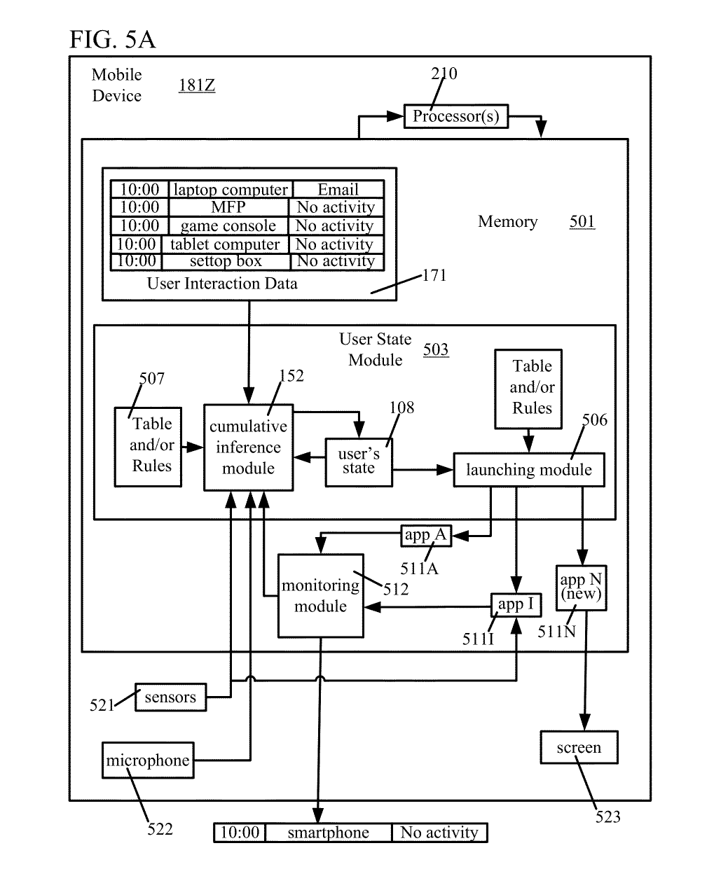

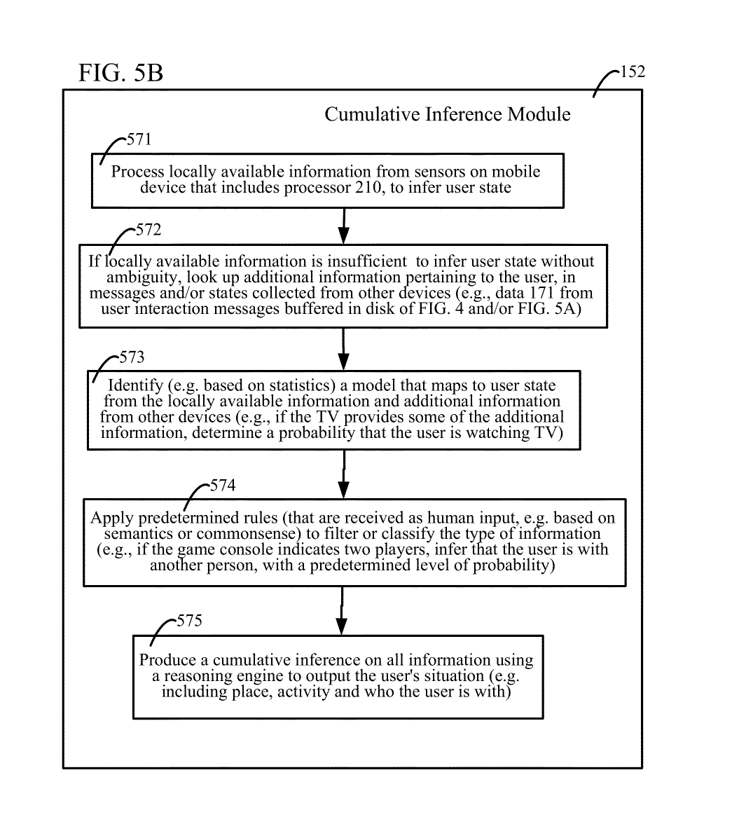

In certain aspects, a server 100 (FIG. 4) on the Internet may be configured as a destination for message sequences 302A-302J from devices 181A-181J in the specific user's office 180 as well as the destination for message sequences 182K-182N from devices 181K-181N in the specific user's home 190. In such aspects, processor 210 (FIG. 2B) is included in server computer 100 and therein performs acts 211-213 and 215 as shown in FIG. 2B except that act 214 (FIG. 2B) is replaced by alternate act. In the alternate act, server computer 100 sends an instruction message to device 181Z to execute a specific app (or a function therein) that is triggered in act 213. In such aspects, device 181Z executes the app identified in the instruction message from server computer 100. So, in aspects of the type illustrated in FIG. 4, the set of devices 181A-181N that generate user interaction messages are in different geographic locations that are interconnected via the Internet. Moreover, in aspects of the type illustrated in FIG. 4, server 100 buffers in a disk 104 the last hour of messages in sequences 302A-302N, for use by processor 210 in computer 100.

In some aspects, mobile device 181Z includes processor 210 (FIG. 5A) that is coupled to a memory 501. Memory 501 includes a module 503 of software instructions (also called user state module) that when executed by processor 210 identify and use user state 108. User state module 503 in turn includes two modules, namely a cumulative inference module 152 and a launching module 506. Cumulative inference module 152 determines one or more parts of user state 108 based on data 171 collected from user interaction messages, by use of one or more rules and/or a table 507 and optionally determines other parts of user state 108 based on input from one or more built-in sensors 521 of mobile device 181Z and/or microphone 522. Launching module 506 uses user state 108 to trigger execution of a function included in one or more of sequences of software instructions for application programs (also called “apps”) 511A-511I and/or begin execution of app 511N.

In some illustrative aspects, launching module 506 is a generic operating system type function that can select and start any app e.g. depending on or independent of the specific user's state 108. In certain aspects, performance of acts 201-206 in a monitoring module 512 (FIG. 5A) is triggered, instead of being done in an endless loop therein which can drain battery of a mobile device 181Z, as follows: launching module 506 triggers functions in corresponding apps 511A and 511I that in turn receive user input and notify monitoring module 512 of user input received in apps 511A and 511I.

Note that launching module 506 is also used to select and start other apps, unrelated to monitoring module 512. For example, an app 511N may be started by launching module 506 based on one or more parts of a specific user's state 108, and app 511N may display appropriate information on a screen 523. Moreover, one or more acts of the type described above for launching module 506 may be combined, depending on the aspect, e.g. functions in apps 511A and 511I may be triggered based on user's state 108.

Processor 210 of some aspects is programmed to execute software in cumulative inference module 152 as follows. In an act 571 (FIG. 5B), processor 210 processes any locally available information (e.g. from sensors 521 in the mobile device 181Z and/or from monitoring module 512), to infer one or more parts of a user state 108. If insufficient information is available to infer all parts of user state 108 without ambiguity, in act 572 processor 210 looks up additional information pertaining to specific user 110 in messages and/or parts of states collected from various electronic devices that are external thereto (e.g., user interaction data 171 that is obtained from messages received in sequences 302A-302N, as shown in FIG. 4 and/or FIG. 5A).

Thereafter, in act 573 processor 210 identifies (e.g. based on statistics) a model that maps to user state from a combination of locally available information and additional information aggregated from other devices. For example, if set-top box 181K of FIG. 1D provides any additional information in a message, use that information to determine that specific user 110's activity is watching TV and a probability of this activity (e.g. depending on the time of the day). In this manner, processor 201 obtains at least a first part of a specific user's state 108, based on the information.

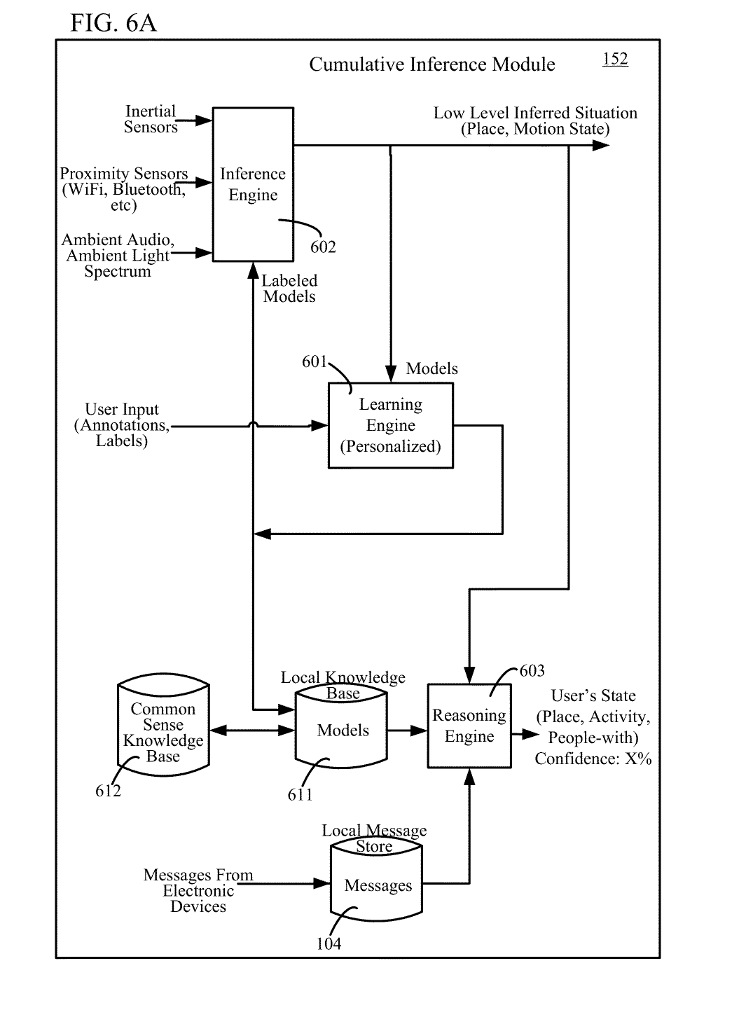

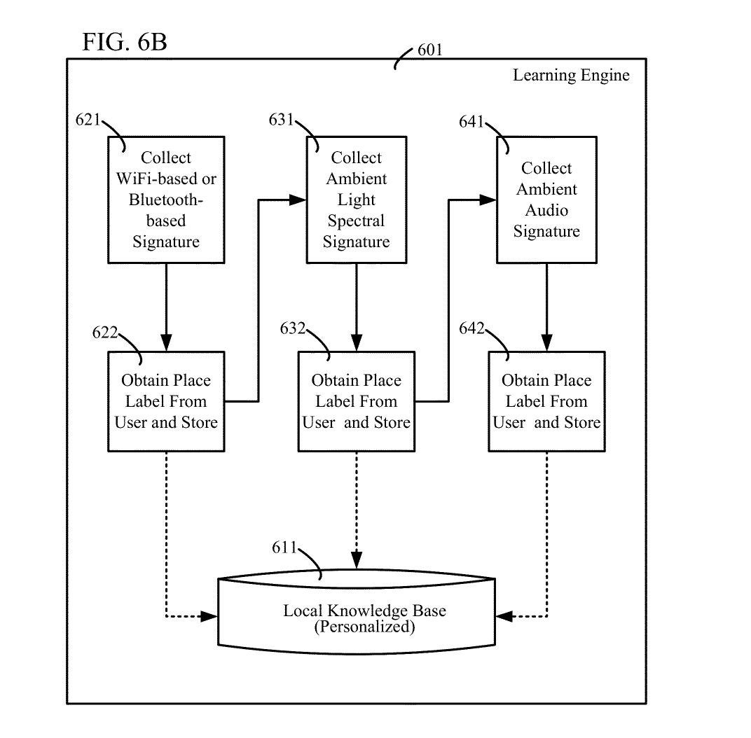

Subsequently, in act 574, processor 210 applies one or more predetermined rules (such as semantic or commonsense rules, e.g. specified in knowledge base 612 of FIG. 6A) to filter or classify the type of internal information. For example, when game console 181L of FIG. 1D indicates in a message of internal information that there are 2 players currently interacting therewith, processor 210 uses rules (or a lookup table) to determine a second part of the user's state, namely that specific user 110 may be with another person, with a predetermined probability.

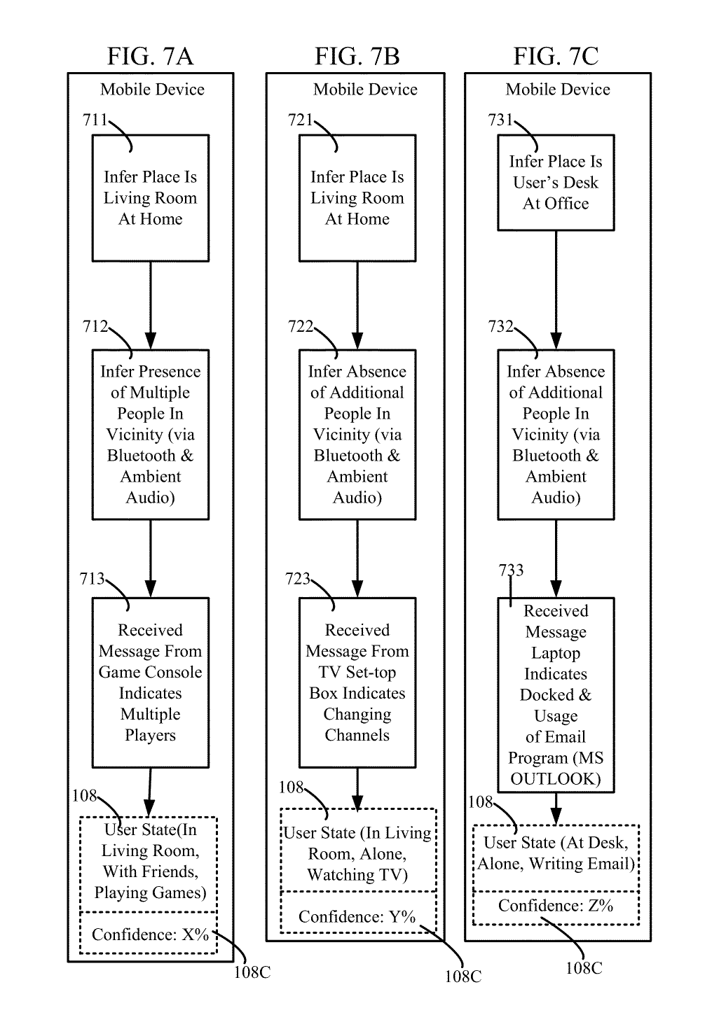

Finally, in act 575, processor 210 produces a cumulative inference on all the above-described parts using a reasoning engine 603 (FIG. 6A) to output all parts of the specific user's state 108 which is indicative of the specific user's situation such as one part indicative of a place in which the specific user is present, another part indicative of an activity being performed by the specific user, and still another part indicative of whether or not the specific user is with other people. In addition to a three-part state 108 as described, engine 603 may output a confidence 108C (FIG. 7A), e.g. based on the probability of each part used to determine the state as described above.

In some aspects, cumulative inference module 152 is implemented by three engines 601-603 illustrated in FIG. 6A. Engine 601 is a learning engine that obtains user input in the form of annotations and/or labels for models of places, for use in identifying the specific user's situation, e.g. as illustrated in FIG. 6B. Specifically, in an act 621 (FIG. 6B), learning engine 601 obtains a signature, in the form of received signal strength (RSS) and identity of each of one or more transmitters of WiFi signal(s) and/or Bluetooth signal(s) that can be sensed by one or more wireless receiver(s) 810 (FIG. 8A) internal to and part of mobile device 181Z. Next, in an act 622 (FIG. 6B), learning engine 601 obtains a label from specific user 110 (e.g. via touch screen 823 in FIG. 8A) to identify the place, and stores the signature (e.g. one or more portions of a WiFi trace sensed by receiver 810) in association with the label as a labeled place model in a local knowledge base 611 (FIG. 6A), now personalized for the specific user 110.

Thereafter, in act 631 (FIG. 6B), learning engine 601 obtains another signature, in the form of ambient light from a light sensor 816 (FIG. 8A) that is internal to and part of mobile device 181Z. Next, in an act 632 (FIG. 6B), learning engine 601 obtains a place label from specific user 110 (or alternatively uses a place label that has just been obtained in act 622), and stores the signature in association with the label (and optionally a current time at which the label is received) in the local knowledge base 611 (FIG. 6A), e.g. in the labeled place model when the label is identical.

Similarly, in act 641 (FIG. 6B), learning engine 601 obtains yet another signature, in the form of ambient audio (sound) from a microphone 822 (FIG. 8A) that is also internal to and part of mobile device 181Z. Next, in an act 642 (FIG. 6B), learning engine 601 obtains a place label from specific user 110 (or alternatively uses a place label that has just been obtained in act 622), and stores the signature in association with the label in the local knowledge base 611 (and optionally the current time of day at which the label is received), also in the labeled place model when the label is identical.

One or more labeled place models in local knowledge base 611 are thereafter used during normal operation, by inference engine 602 (FIG. 6A) as follows. Specifically, inference engine 602 obtains signatures of the type described above, from wireless transmitter & receiver 810, light sensor 816, and microphone 822, and compares the signatures with corresponding signatures in labeled place models stored in local knowledge base 611, to identify a specific place at which specific user 110 is currently located (e.g. specific user's office 180). In addition, inference engine 602 also obtains one or more measurements made by one or more inertial sensors 817 (e.g. accelerometer, compass, or gyroscope), to determine a low-level state, such as a state of motion of the specific user, e.g. whether the specific user is stationary or moving.

The above-described place and motion, which have been identified by inference engine 602, constitute a low level inferred situation of specific user 110, in several aspects. This low level inferred situation is thereafter used by reasoning engine 603 (e.g. with a lookup table), to identify one part of the specific user's state 108. In some aspects, in addition to the low level inferred situation, reasoning engine 603 additionally uses (e.g. with another lookup table) the above-described labeled place models as well as information on the specific user's interaction with one or more electronic devices 181A-181N that are external to the mobile device 181J, to determine another part of the specific user's state 108 (described above). In some aspects, reasoning engine 603 also identifies a confidence 108C, as a percentage, associated with the specific user's state 108, as described in the next two paragraphs.

FIGS. 7A-7C illustrate, in high-level flow charts, acts performed by a mobile device during normal operation, in some of the described aspects. Specifically, in a first illustrative aspect shown in FIG. 7A, mobile device 181Z (or computer 100) determines a first part of the user's state in act 711, namely that a place where the user is currently located is a living room in that user's home, e.g. based on any measurements by sensors therein (in comparison with models of signals in each place), e.g. sound measurements or measurements of wireless signals by the user's mobile device 181Z. Next, in act 712, mobile device 181Z (or computer 100) determines a second part of the user's state, namely that there the user is not alone, specifically that there are one or more people in the vicinity of the user. The determination in act 712 may be made, in some aspects, based on one or more measurements of Bluetooth signals, and ambient sounds by the user's mobile device 181Z (in comparison with models of signals for a single user). Then, in act 713, mobile device 181Z (or computer 100) determines a third part of the user's state, namely that there are multiple players, based on one or more messages (identifying the number of users) received from a game console 181L in the user's home 190. Finally, mobile device 181Z (or computer 100) generates user's state 108 by combining therein the three parts, based on the results of the just-described three decisions 711, 712 and 713. In this manner, a three-part user state 108 is determined by mobile device 181Z (or computer 100) to be: User State (In Living Room, With Friends, Playing Games).

In some embodiments, acts 711-713 described in the preceding paragraph above are all performed within mobile device 181Z, and one or more measurements are performed locally within mobile device 181Z by one or more sensors 817 (such as a compass, a gyroscope), or by wireless receiver 810 that are operatively coupled to processor 210 and memory 801 as illustrated in FIG. 8A. In several such embodiments, processor 210 receives from user's computer 181I (FIG. 1D), a single message in which data 107 indicates that user input is being currently received (e.g. via a keyboard) in a predetermined group of applications (e.g. “productivity” applications), while other predetermined groups of applications (e.g. “entertainment” applications) are not being used by the user. Hence, processor 210 uses this data 107 received in a single message, in combination with locally-made measurements from sensors in mobile debice 181Z, to cumulatively determine the user's state, in the manner described above.

In some embodiments, a confidence 108C is additionally determined (by computer 100 or by mobile device 181Z), e.g. to be a smallest probability among all probabilities associated with individual parts used to determine the user's state 108. Hence, in the above-described example, confidence 108C is determined to be the Confidence X %=minimum of (1) Probability of (In Living Room), (2) Probability of (With Friends), and (3) Probability of (Playing Games). A specific manner in which such probabilities are identified for each part of a state can be different, depending on the embodiment, and in some embodiments such probabilities are obtained by use of one or more lookup tables (LUTs) using details based on internal information obtained from one or more electronic devices 181A-181N and optionally with information obtained from one or more sensors and/or apps in mobile device 181Z (FIG. 1D). In some aspects, a confidence 108C that is obtained as described above (in this current paragraph) may be adjusted automatically, e.g. based on previous occurrences of a specific combination of parts of the user's state, and/or based on a specific time of the day (such as evening, or weekend or holiday).

In a second illustrative aspect shown in FIG. 7B, mobile device 181Z (or computer 100) determines the first part of the user's state in act 721, namely that a place where the user is currently located is a living room in that user's home, as described above. Next, in act 722, mobile device 181Z (or computer 100) determines the second part of the user's state, namely that there the user is alone, e.g. based on measurements of Bluetooth signals, and ambient sounds. Then, in act 723, mobile device 181Z (or computer 100) determines the third part of the user's state, based on a message received from a TV Set-top box 181K in the user's home 190, namely that the user 110 is changing channels. Hence, mobile device 181Z (or computer 100) generates a three-part state in this example by combining the above-described three parts, based on the results of the just-described decisions 721, 722 and 723. Thus user state 108 may be automatically determined to be: User State (In Living Room, Alone, Watching TV). User state 108 may be associated with a confidence 108 C of Y % (FIG. 7B).

In a third illustrative aspect shown in FIG. 7C, mobile device 181Z (or computer 100) determines the first part of the user's state in act 731, namely that a place where the user is currently located is an room at that user's work, as described above. Next, in act 732, mobile device 181Z (or computer 100) determines the second part of the user's state, namely that there the user is alone, e.g. based on measurements of Bluetooth signals, and ambient sounds. Then, in act 733, mobile device 181Z (or computer 100) determines the third part of the user's state, based on a message received from a laptop 181J in the user's office 180 that the user 110 is using an Email program that the user is writing email. Hence, mobile device 181Z (or computer 100) generates a three-part state by combining the above-described three parts, based on the results of the just-described decisions 731, 732 and 733. Thus user state 108 may be automatically determined to be: User State (At Desk, Alone, Writing Email). User state 108 may be associated with a confidence 108C of Z % (FIG. 7C).

In some aspects, all steps illustrated in FIGS. 7A-7C may be performed by a mobile device 181Z in which case the first two acts (e.g. acts 711 and 712 in FIG. 7A) use information from sensors 521 within device 181Z. More specifically, in such aspects, a processor in device 181Z determines two parts of state 108 by monitoring of applications that execute internally in mobile device 181Z. Mobile device 181Z performs the third act (e.g. act 713 in FIG. 7A) to determine a third part of state 108 based on internal information obtained from an electronic device 181I that is external to (and operably coupled to) mobile device 181Z. In alternative aspects, a computer 100 performs the first two acts (e.g. acts 711 and 712 in FIG. 7A) using internal information obtained from mobile device 181Z (after authentication) via a message sequence 182Z (FIG. 1D). More specifically, in such alternative aspects, a processor in computer 100 determines two parts of state 108 from information that is received from mobile device 181Z. Computer 100 additionally performs a third act (e.g. act 713 in FIG. 7A) to determine a third part of state 108 based on additional internal information that is received from another electronic device 181I. Therefore, in determining user state 108, computer 100 uses information that is internal to each of at least two devices, namely device 181Z and device 181I. Computer 100 then transmits user state 108 to device 181Z, e.g. for use in executing a function therein.

Hence, computer 100 or mobile device 181Z or a combination thereof, implement a method of automatically learning information on a user 110, based on this user's interaction with one or more electronic devices 181A-181N, for cumulative inference of the user's situation, e.g. expressed as user state 108 and confidence 108C. The user's situation inferred in such a manner may further include, for example, an indication of content with which user 110 is interacting, such as a title of a movie the user 110 is watching, or a name of a file the user 110 is editing, or a subject of an email that user 110 is reading or writing. Based on the state of the user, in some aspects of the method include a mobile device triggering execution of a function in an application or starts execution of a new application.

As illustrated in FIG. 8A, user's device 181Z of some aspects is a mobile device, such as a smartphone that includes sensors 521, such as accelerometers, gyroscopes or the like, which may be used in the normal manner, and measurements made locally therein may be used in determining state 108 in act 105 in combination with data received from one or more electronic devices 181A-181N. Also, mobile device 181Z may additionally include a graphics engine 1004 and an image processor 1005 that are used in the normal manner. Mobile device 181Z may optionally include other types of memory such as flash memory (or SD card) 1008 or hard disk to store data and/or software for use by processor(s) 210. Mobile device 181Z may further include a wireless transmitter and a wireless receiver in a wireless transceiver 1010 and/or any other communication interfaces, and measurements therefrom (such as a WiFi traces) may additionally be used in determining state 108 in act 105. Mobile device 181Z may be connected wirelessly (and operably) to a server computer 100.

It should be understood that mobile device 181Z (also called “mobile station”) may be any portable electronic device such as a cellular or other wireless communication device, personal communication system (PCS) device, personal navigation device (PND), Personal Information Manager (PIM), Personal Digital Assistant (PDA), laptop, camera, smartphone, or other suitable mobile platform that is capable of using a specific user's state 108 to display information customized for that specific user by an application (or a function therein) that is triggered based on the user's state 108, e.g. display of promotional statements, e.g. advertisements from advertisers. Such information may be displayed visually by mobile device 181Z e.g. on a visual display in a touch screen.

The term “mobile station” (also called “mobile device”) is also intended to include devices which communicate with a personal navigation device (PND), such as by short-range wireless, infrared, wire-line connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, WiFi, or other wired and/or wireless network, and regardless of whether generation of user's state 108 occurs at the device, at a server, or at another device associated with the network. Any operable combination of the above are also considered a “mobile station.”

A mobile device 181Z of the type described above may also use position determination methods and/or object recognition methods based on “computer vision” techniques. The mobile device 181Z may also include means for receiving information, in response to user input on another electronic device 181I e.g. by use of transmitter in a wireless transceiver 1010, which may be an IR or RF transmitter or a wireless a transmitter enabled to transmit one or more signals over one or more types of wireless communication networks such as the Internet, WiFi, cellular wireless network or other communications network. Mobile device 181Z may further include, in a user interface, a microphone 522 and a speaker (not labeled). Of course, mobile device 181Z may include other elements unrelated to the present disclosure, such as a read-only-memory 1007 which may be used to store firmware for use by processor 210.

Although several embodiments are illustrated in connection with specific aspects for instructional purposes, embodiments described herein are not limited thereto. Hence, although item 181Z shown in FIGS. 3A and 3B of some aspects is a mobile device, in other aspects devices 181A-181N and/or 181Z may be implemented by use of form factors that are different, e.g. in certain other aspects item 181Z is a mobile platform (such as an iPad available from Apple, Inc.) while in still other aspects item 181Z is any electronic device or computer system (including any combination of hardware and software of the type described herein) that may be mobile or stationary. Illustrative aspects of such an electronic device or system 181Z may include multiple physical parts that intercommunicate wirelessly, such as a processor and a memory that are portions of a mobile device, such as a laptop. In some aspects, devices 181A-181N are stationary devices, such as a desk-top computer, a printer, etc. Electronic device or system 181Z may communicate wirelessly, directly or indirectly, with one or more electronic devices 181A-181N each of which has one or more sensors 309 (FIG. 8C) coupled internally to user input circuitry (within the housing of devices 181A-181N).

Many of the methodologies described herein may be implemented by various means depending upon applications according to particular features and/or examples. For example, such methodologies may be implemented in hardware, firmware, software, and/or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit (or processor) having a command set which includes the encoded commands. Such an instruction may be encoded in the form of a machine language understood by the processing circuit (or processor). Again, these are merely examples of an instruction and claimed subject matter is not limited in this respect.

“Storage medium” as referred to herein relates to non-transitory computer readable medium capable of maintaining expressions which are perceivable by one or more machines. For example, a storage medium may comprise one or more storage devices for storing machine-readable instructions and/or information. Such storage devices may comprise any one of several media types including, for example, magnetic, optical or semiconductor storage media. Such storage devices may also comprise any type of long term, short term, volatile or non-volatile devices memory devices. However, these are merely examples of a storage medium and claimed subject matter is not limited in these respects.

In some aspects, a server computer 100 (FIG. 1D) is implemented as illustrated in FIG. 8B. Specifically, computer 100 includes in a memory 801, an authentication module 151 in the form of instructions that when executed by a processor cause the processor to authenticate a set of electronic devices that may be identified in memory 801, by use of credentials of the user, wherein the information is specific to the user that has been identified by the credentials. Moreover, computer 100 includes memory 801 a monitoring module 512 in the form of instructions that when executed by a processor cause the processor to be responsive to receipt of a message from an electronic device, by storing in memory 801, information received in the message. As discussed above, such a message may indicate user input in a module (e.g. hardware and/or software) located within an electronic device, and optionally indicate an identifier of the electronic device and optionally indicate information that is normally internal to the electronic device, the internal information including an identifier of the module with which a user is currently interacting.

Computer 100 further includes in memory 801, a cumulative inference module 152 in the form of instructions that when executed by a processor cause the processor to determine (and store in memory 801 operatively coupled to the processor) a state 108 of user 110, based on at least the internal information (indicative of interaction of user 110 with one or more electronic devices) that is received in multiple messages. Computer 100 also includes in memory 801, a state transmission module 887 in the form of instructions that when executed by a processor cause the processor to transmit (e.g. via a wireless transmitter 1010) the state of a specific user 110, to a mobile device 181Z of that specific user 110.

It is to be understood that several other aspects of the invention will become readily apparent to those skilled in the art from the description herein, wherein it is shown and described various aspects by way of illustration. The drawings and detailed description are to be regarded as illustrative in nature and not as restrictive.

1. A method of automatically learning information on a user, comprising:
receiving one or more messages from a set of one or more electronic devices operatively coupled to a communications network;
wherein at least one message received by the receiving comprises:
an identifier that uniquely identifies an electronic device in the set of one or more electronic devices; and
information internal to the electronic device, the information comprising an identification of a module with which the user is currently interacting, the module being uniquely identified by the identification from among one or more modules comprised within the electronic device;
determining, by a processor, a state of the user based on at least the information internal to the electronic device and the identifier received in the at least one message; and
storing in a memory operatively coupled to the processor, the state of the user.

2. The method of claim 1 further comprising:
prior to the receiving, authenticating the electronic device by use of credentials of the user;
wherein the at least one message received by the receiving is specific to the user identified by the credentials.

3. The method of claim 1 wherein:
the processor and the memory are comprised in a mobile device and operably connected to one another; and
the electronic device is external to the mobile device.

4. The method of claim 1 further comprising:
the processor transmitting the state of the user to a mobile device;
wherein the electronic device is external to the mobile device.

5. The method of claim 1 wherein:
the determining comprises using a prior value of the state of the user.

6. The method of claim 1 wherein:
the module comprises application software within the electronic device.

7. The method of claim 1 wherein:
the module comprises hardware circuitry within the electronic device.

8. The method of claim 1 further comprising:
based on the state of the user, a mobile device triggering execution of a function in an application or starting execution of a new application.

9. The method of claim 1 wherein:
the processor determines a first part of the state based on the information;
the processor determines a second part of the state based on additional information comprising at least one measurement from a sensor.

10. The method of claim 1 wherein:
the processor determines a first part of the state based on the at least one message, in the one or more messages received from the set; and
the processor determines a second part of the state based on another message, in the one or more messages received from the set.

11. A non-transitory computer readable medium comprising instructions to perform a method of automatically learning information on a user, the instructions comprising:
instructions to receive at least one message from a set of one or more electronic devices that are operatively coupled to a communications network;
wherein the at least one message received on execution of the instructions to receive comprises:
an identifier of an electronic device in the set of one or more electronic devices; and
information internal to the electronic device, the information comprising an identification of a module with which the user is currently interacting, the module being comprised among multiple modules in the electronic device;
instructions to determine a state of the user based on at least the information received in the at least one message; and
instructions to store in a memory at least the state of the user.

12. The non-transitory computer readable medium of claim 11 further comprising:
instructions to authenticate the set of one or more electronic devices, by use of credentials of the user;
wherein the at least one message is specific to the user identified by the credentials.

13. The non-transitory computer readable medium of claim 11 wherein:
the set of one or more electronic devices are external to a mobile device that executes at least the instructions to store.

14. The non-transitory computer readable medium of claim 11 further comprising:
instructions to transmit the state of the user to a mobile device;
wherein the set of one or more electronic devices are external to the mobile device.

15. The non-transitory computer readable medium of claim 11 further comprising:
instructions to use a prior value of the state of the user.

16. The non-transitory computer readable medium of claim 11 wherein:
the module comprises application software within the electronic device.

17. The non-transitory computer readable medium of claim 11 wherein:
the module comprises hardware circuitry within the electronic device.

18. The non-transitory computer readable medium of claim 11 further comprising:
instructions to trigger a function in an application or start execution of a new application, based on the state of the user.

19. The non-transitory computer readable medium of claim 11 further comprising:
instructions to monitor applications executing in a mobile device, to generate additional information;
wherein the set of one or more electronic devices are external to the mobile device.

20. A mobile device comprising:
a plurality of sensors;
a wireless transceiver;
a processor operatively coupled to the plurality of sensors and the wireless transceiver;
memory operatively coupled to the processor;
a display operatively coupled to the memory; and
software stored in the memory and executable by the processor to cause the processor to:
obtain a state of a user, wherein the state depends on information normally internal to an electronic device in a set of one or more electronic devices that are operatively coupled to a communications network, the information comprising an identifier of a module with which the user is currently interacting, the module being comprised among multiple modules in the electronic device; and
trigger a function in an application or start execution of a new application, based on the state of the user.

21. The mobile device of claim 20 wherein:
the state of the user is obtained by the processor, from a computer that determines the state based on receipt of the information in at least one message generated by the electronic device.

22. The mobile device of claim 20 wherein:
the state of the user is obtained by the processor from the memory; and
prior to obtaining the state, the processor storing the state in the memory after determining the state based on receipt of the information in at least one message generated by the electronic device.

23. The mobile device of claim 20 wherein:
a prior value of the state of the user is used by the processor, in determining the state.

24. The mobile device of claim 20 wherein:
before obtaining the state, the set of one or more electronic devices are authenticated by use of credentials of the user; and
the information is specific to the user identified by the credentials.

25. A computer comprising:
a processor;
memory operatively coupled to the processor;
software stored in the memory and executable by the processor to cause the processor to:
receive at least one message from a set of one or more electronic devices that are operatively coupled to a communications network;
wherein each message comprises:
an identifier of an electronic device in the set of one or more electronic devices; and
information normally internal to the electronic device, the information comprising an identification of a module with which a user is currently interacting, the module being comprised among multiple modules in the electronic device;
determine a state of the user based on at least the information in the at least one message; and
store in the memory at least the state of the user.

26. The computer of claim 25 wherein the software further causes the processor to:
authenticate the set of one or more electronic devices, by use of credentials of the user;
wherein the information is specific to the user identified by the credentials.

27. The computer of claim 25 wherein the software further causes the processor to:
transmit to a mobile device, at least the state of the user;
wherein the set of one or more electronic devices are external to the mobile device.

28. A system for learning about a user, the system comprising:
a set of one or more electronic devices operatively coupled to a communications network, the set of one or more electronic devices being configured to generate at least one message;
wherein in response to receipt of input from the user in a module in an electronic device in the set of one or more electronic devices, the at least one message is transmitted by the electronic device and comprises:
an identifier of the electronic device; and
information normally internal to the electronic device, the information comprising an identification of the module with which the user is currently interacting; and
means for determining a state of the user based on at least the information in the at least one message.

29. The system of claim 28 further comprising:
means for authenticating the set of one or more electronic devices, by use of credentials of the user;
wherein the information is specific to the user identified by the credentials.

30. The system of claim 28 further comprising:
means for transmitting to a mobile device, at least the state of the user;
wherein the set of one or more electronic devices are external to the mobile device.

31. The system of claim 28 wherein:
the means for determining is comprised in a mobile device; and
the mobile device is coupled by the communications network, to the set of one or more electronic devices, to receive therefrom the at least one message.
